(19) United States
(12) Patent Application Publication
(10) Pub. No.: US 2011/0106836 A1
(43) Pub. Date: May 5, 2011

(54) Semantic Link Discovery

(75) Inventors: Oktie Hassanzadeh, Toronto (CA); Anastasios Kementsietsidis, Hawthorne, NY (US); Lipyeow Lim, Honolulu, HI (US); Min Wang, Hawthorne, NY (US)

(73) Assignee: INTERNATIONAL BUSINESS MACHINES CORPORATION, Armonk, NY (US)

(21) Appl. No.: 12/609,657

(22) Filed: Oct. 30, 2009

(51) Int. Cl. G06F 17/30

(52) U.S. Cl. 707/769; 707/E17.014

(57) ABSTRACT

A method of semantic link discovery through translation of basic declarative language includes receiving a set of linkage specifications, receiving a set of data sources related to the linkage specifications, the set of data sources and the set of linkage requirements forming a basic declarative language query, translating the basic declarative language query into a standard language query, executing the standard language query, and returning results of the standard language query in response to the executing.

### FIELD

This application relates to semantic link discovery, and in particular, to a declarative framework for semantic link discovery over relational data.

### BACKGROUND

Generally, discovering links between different records in data sources is a challenging problem faced in many data management applications. The existence of links adds value to data sources, enhances data and information discovery, and allows or enhances many increasingly important data mining tasks. In many existing data sources, such as documents and web pages on the World Wide Wed, links are usually set manually by document authors or semi-automatically by data publishers using domain-specific rules. Many structured or semi-structured data sources, such as semantic Web data sources, are derived from existing web documents using information extraction techniques or from existing relational databases. The large size of these data sources often prohibits publishers from manually setting links to other related data sources. This may result in a problem often referred to as “islands of data” or “data silos”.

One goal of the recently established linking open data (LOD) community project at W3C is to fill the existing gap in the semantic Web (or Web of Data) by providing high quality data sources that are semantically interlinked. The LOD data sources have had an enormous growth, currently providing billions of data records in the form of RDF triples (predicates in the form of “subject, relationship, object”) in various domains. Part of the success of the LOD project and its recent growth is due to the development of tools and frameworks that allow generating and publishing resource description framework (RDF) data from data stored in relational databases. Specifically, frameworks such as D2RQ, TRIPLIFY, or VIRTUOSO allow data publishers to publish data in the form of RDF triples from data stored in a relational database management system (RDBMS), based on a declarative specification of mapping between the relational and RDF data. These frameworks have significantly simplified the process of publishing a semantic Web data source.

However, discovering links between data items stored in relational data sources remains a difficult problem. The number of interlinked entities in existing LOD data sources is almost three orders of magnitude less than the number of data records. The majority of these links are either a result of existing links in the relational data (e.g., links between two data items that are both derived from a single web page, both having the same URL), or laborious implementation of a semi-automatic and domain-specific linkage algorithm.

### SUMMARY

According to at least one example embodiment, a method of semantic link discovery through translation of basic declarative language includes receiving a set of linkage specifications, receiving a set of data sources related to the linkage specifications, the set of data sources and the set of linkage requirements forming a basic declarative language query, translating the basic declarative language query into a standard language query, executing the standard language query, and returning results of the standard language query in response to the executing.

According to another example embodiment, method of semantic link discovery through translation of basic declarative language includes receiving a set of linkage requirements, receiving a set of primitive linkage specifications, receiving a set of data sources related to the primitive linkage specifications and linkage requirements, the set of data sources, the set of primitive linkage requirements, and the set of linkage requirements forming a basic declarative language query, translating the basic declarative language query into a standard language query, executing the standard language query, and returning results of the standard language query in response to the executing.

According to another example embodiment, a computer readable storage medium includes computer executable instructions that, when executed on a computer processor, direct the computer processor to perform a method of semantic link discovery through translation of basic declarative language. The method includes receiving a set of linkage specifications, receiving a set of data sources related to the linkage specifications, the set of data sources and the set of linkage requirements forming a basic declarative language query, translating the basic declarative language query into a standard language query, executing the standard language query, and returning results of the standard language query in response to the executing.

### BRIEF DESCRIPTION OF THE SEVERAL VIEWS OF THE DRAWINGS

FIG. 1 is a diagram including sample relations between records across a plurality of data sources;

FIG. 2 is a flowchart of a method of semantic link discovery, according to an example embodiment;

FIG. 3 is a flowchart of a method of semantic link discovery, according to an example embodiment;

FIG. 4 is a flowchart of a method of semantic link discovery, according to an example embodiment; and

FIG. 5 is a computing apparatus, according to an example embodiment.

### DETAILED DESCRIPTION

Detailed illustrative embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein a database management system (DBMS) is any system and/or group of computer program(s) disposed to create, maintain, and/or utilize a database(s) and semantic information stored in said database(s).

Example embodiments provide a generic and extensible framework for locating links between relational data sources. Users of the framework may use a basic declarative language to describe subsets of data to be linked, any sources containing the data both local and external, and algorithms to be used for finding links between local and external data. The basic declarative language may be subsequently processed to coincide or be compatible with a standard declarative language through intelligent parsing and merging. For example, the basic declarative language may be processed to be similar to structured query language (SQL) or any other suitable language. Through the processing, the basic language is expressed such that more sources may be accessed through the use of one framework, in comparison with user-extensive manipulation of several different declarative languages to achieve the same result.

The declarative specification may be translated into a computer program disposed to locate the links between the local and external data. Such programs may be implemented using programming languages similar to Java or C by third-party developers, and are automatically invoked with arguments defined through the declarative specification. It follows that these programs act as black-boxes that reside outside the data publishing framework and whose modification requires aid from developers. Example embodiments address these shortcomings by providing a basic SQL implementation for a number of link finding algorithms. Example embodiments have several advantages including the ability to implement the basic framework on existing relational data sources with reduced effort and without need for externally written program code. Example embodiments take advantage of the underlying DBMS optimizations in a query engine while evaluating the SQL implementations of the link finding algorithms. Example embodiments also use specific efficiency and functionality enhancements to improve the effectiveness of these algorithms.

Hereinafter, example embodiments will be described in detail with reference to the attached drawings.

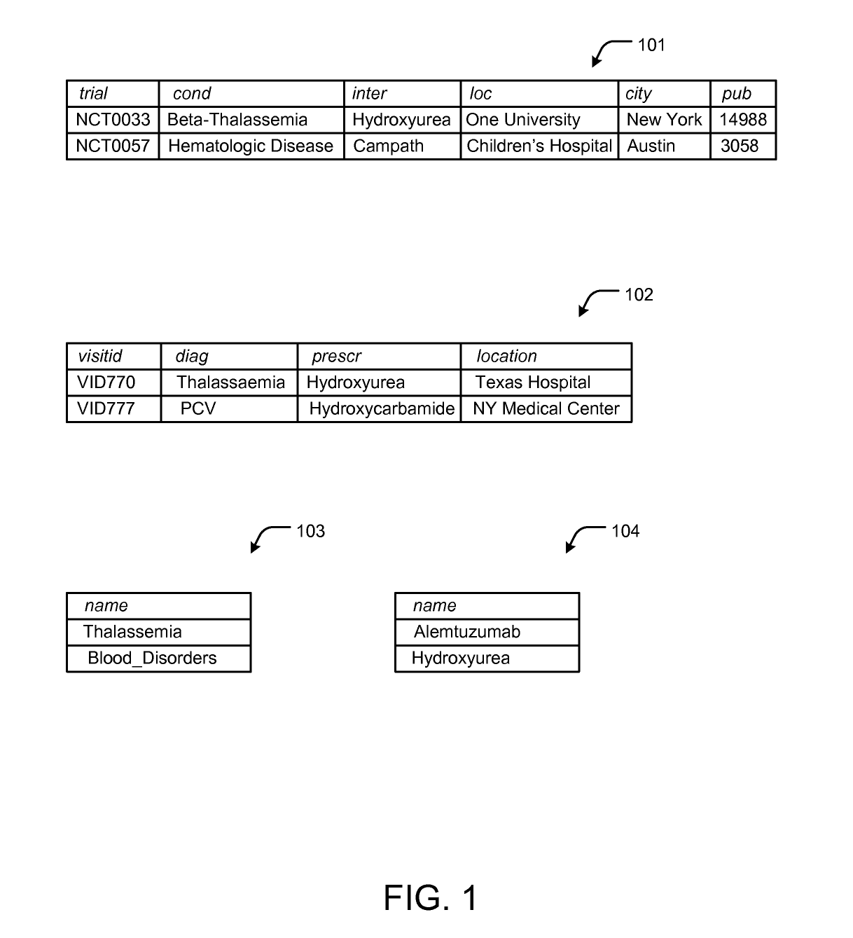

FIG. 1 is a diagram including sample relations between records across a plurality of data sources. It is noted that FIG. 1 is provided as an example of relational data only, and the particular forms and types of information are provided for illustrative purposes only, and thus should not be construed as limiting.

Illustrated are relational data provided from a plurality of sources. For example, a first source may provide relational data 101, a second source may provide relational data 102, a third source may provide relational data 103, and a fourth source may provide relational data 104.

Data 101 includes six columns representing, for example, clinical trial information. The first column identifies a trial number, the second column identifies a clinical condition, the third column identifies a suggested intervention, the fourth column identifies a location, the fifth column identifies a city, the sixth column identifies a related publication.

Data 102 includes four columns representing, for example, patient electronic medial records (EMR) and includes patient visitation relations. The first column identifies a visit ID, the second column identifies a diagnosis, the third column identifies a recommended prescription, and the fourth column identifies a location.

Data 103 and 104 include a single column representing, for example, information about prescriptions and illnesses.

In the relational data illustrated in FIG. 1, there may be a plurality of links desired based on the context of a user's query. For example, a publisher desiring links to relational data involving the example data of FIG. 1 may wish links to be discovered between the condition column of data 101 and the diagnosis column of data 102. Further, patient visit “VID770” with diagnosis “Thalassaemia” in the data 102 relation should be linked to the trial “NCT0057” with condition “Hematologic Diseases” because “Thalassemia” is a type of “Hematologic Disease”. Similarly, note that the intervention column in the data 101 relation may be linked to the prescription column in the data 102.

Additional correlations are possible considering the existence of links between the locations noted in the relational data. Thus correlations between city information and location information may be linked, in addition to other links as well.

Hereinafter, methods of semantic link discovery are described in detail.

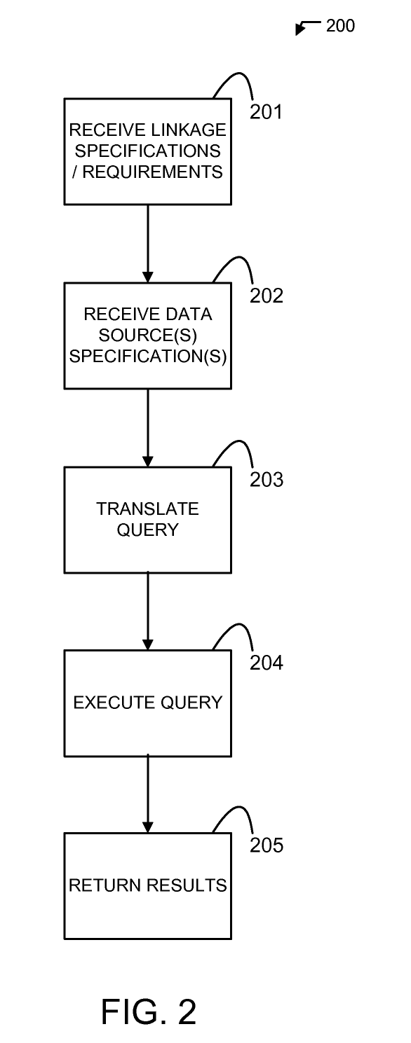

FIG. 2 is a flowchart of a method of semantic link discovery, according to an example embodiment. The method 200 includes receiving linkage specifications/requirements at block 201. For example linkage specifications define the conditions that two given values must satisfy before a link may be established between said values. For example, Table 1 below defines a linkage specification using a basic declarative language:

TABLE 1

linkspec_stmt:= CREATE LINKSPEC linkspec_name

AS link_method opt_args opt_limit;

linkindex_stmt:= CREATE LINKINDEX

opt_idx_args linkindex_name

ON table(col)
USING link_method;

link_method:= native_link |link_clause_expr |UDF;
native_link:= synonym |hyponym |stringMatch;
link_clause_expr:= link_clause AND link_clause_expr

|link_clause OR link_clause_expr
|link_clause;

link_clause:= LINK source WITH target

USING link_terminal opt_limit;

link_terminal:= native_link |UDF |linkspec_name
opt_limit:= LINKLIMIT number;

As shown in Table 1, the “CREATE LINKSPEC” statement defines a new linkage specification and accepts as parameters the name of the linkage specification and the names of relation columns whose values need to be linked (see FIG. 1). As also shown, the “native_link” establishes methods/algorithms for string matching which may be part of the linkage specification. For example, these algorithms may be based upon previously understood linkage algorithms including string similarity functions.

The “CREATE LINKINDEX” statement may be used to define a link index to speed up the linkage query execution. When a link index is defined, the output will contain a set of {\it preprocessing} queries that should be run prior to the other queries. This is particularly useful when the data is static where preprocessing can significantly reduce the query execution time.

A link specification may also be defined in terms of link clause expressions. Link clause expressions are boolean combinations of link clauses, where each link clause is semantically a boolean condition on two columns and is specified using either a native method, a user-defined function (UDF), or a previously defined linkage specification. It is noted that there is a mutually recursive nature of linkage specifications and link clauses. A linkage specification may be defined using link clauses while a link clause may be specified using previously defined linkage specifications.

The links between values are not necessarily one-to-one and, in general, a value from one relation may be linked to more than one value from a second relation. For example, it is common for medications to have more than one name. Therefore, while a medication appears as “aspirin” in one relation it might appear as “acetylsalicylic acid” or “ASA” in another. When such multiple links are possible, users often desire to limit the number of such links and only consider ‘k’ results, or the top-k if ordering is possible. The “LINKLIMIT” variable of Table 1 essentially specifies the value of this ‘k’ parameter.

It is noted that the “LINKLIMIT” variable may be considered in both local and global terms. For example, “LINKLIMIT” may be associated with a particular clause, or may be associated with an entire linkage specification. Thus the global variable form may be thought of as a post-processing filter of the links returned by the linkage specification methods used.

Hereinafter, user-defined functions and native methods which may be included in linkage specifications are described in detail.

A difference between utilizing a UDF versus a native linkage specification method is that the UDF allows only simple substitution-based rewriting of the query, whereas the native linkage specification methods use a non-trivial rewriting of the query into SQL which is discussed further below with reference to the remainder of the method 200.

The ability to use UDFs in link specification is provided for extensibility to non-SQL-based linking functions. Native implementations may have advantages however. Using native implementations, the query optimizer may optimize the processing of linkage specifications yielding efficient execution times. Furthermore, declarative implementations of the methods within a relational engine permit extensibility.

In a UDF, a user may implement a tailored similarity function based on a set of Boolean values which are relatively easy to translate into a standard query language. For example, a UDF may include simple arguments for returning a Boolean value if two or more strings include an “edit similarity” above a threshold value. The user may also define costs associated with deleting characters, inserting characters, and substituting characters to further refine the “edit similarity”.

Native methods, however, may provide more complex string matching specifications. In a data source, some relevant portions of data are stored in the form of strings. String data is prone to several types of inconsistencies and errors including typos, spelling mistakes, use of abbreviations, or different conventions. Therefore, finding similar strings, or approximate string matching, is an important feature of an (online) link discovery framework. Approximate string matching may be performed based on a similarity function sim( ) that quantifies the amount of closeness (as opposed to distance) between two strings. A similarity threshold θ is set by a user to specify there is a link from the base record to the target record if their similarity score, returned by function sim( ) is above θ. The right value of the threshold depends on the characteristics of the dataset, the similarity function, and the application. The user may find the optimal value of the threshold for each application by attempting different thresholds and manually evaluating the results.

There exists a variety of similarity functions for string data. The performance of a similarity function usually depends on the characteristics of data, such as length of the strings, and the type errors and inconsistencies present in the data.

A class of string similarity functions is based on tokenization of the strings into q-grams (i.e., substrings of length q of the strings). Through use of q-gram tokens, strings may be considered sets of tokens and use a set similarity measure as the measure of similarity between two strings. Furthermore, q-gram generation, storage, and set similarity computation may all be performed in SQL. Thus there are several classes of functions applicable to example embodiments.

One such class includes size of the intersection of the two sets of q-grams (i.e., the number of common q-grams in two strings).

Another class includes Jaccard similarity of two sets of q-grams, which is the size of the intersection set over the size of the union (i.e., the percentage of common q-gram tokens between two strings).

Another class includes a weighted version of the above classes. The weight of each q-gram is associated with its commonality in the base (or target or both) data sources. The higher the weight of a q-gram, the more important the q-gram is. For example, if matching diagnosis across medical sources, q-grams for commonly occurring strings such as “Disorder” or “Cancer” should have low weights such that the value of the similarity function for the strings “Coagulation Disorder” and “Phonation Disorder” is small, compared to that for the strings “Coagulation Disorder” and “Coagulation Disease”.

There are several other string similarity measures including but not limited to, Edit-Similarity, Jaro, Jaro-Winkler, SoftTFIDF, Generalized Edit similarity, and methods derived from relevance score functions for documents in information retrieval, namely Cosine with tf-idf, Okapi-BM25, Language Modeling and Hidden Markov Models. Some of these functions can be implemented in SQL and some others can only be implemented using a UDF. However, the above set-similarity based measures may be applicable due to their accuracy, efficiency, and their flexibility for functionality and efficiency enhancements, as discussed below.

One such string similarity class includes Token Weight Assignment. To assign weights to q-gram tokens, an approach similar to the Inverse Document Frequency (IDF) metric in information retrieval may be used. IDF weights reflect the commonality of tokens in documents with tokens that occur more frequently in documents having less weight. Thus, by analyzing (offline) the q-gram token frequency, less weight is assigned to common tokens like “Disorder” or “Cancer” in a medical source. As a functionality enhancement, the user may manually specify, in a user-defined table, the weights of some tokens. These weights override the automatically assigned (IDF-based) weights for these tokens. Manual weight-assignment is useful in applications where a user has prior knowledge about the importance of some tokens. For example, if matching diagnosis across sources, the user may understand that often the use of numbers plays a more important role in the diagnosis than the name of the disease itself. Thus, by assigning a very low (or negative) weight to numbers, incorrect matches between highly similar strings such as “Type 1 Diabetes” and “Type 2 Diabetes” may be avoided. Similarly, if matching conditions (e.g., “Diabetes”, “Cancer”) from an online source to their corresponding entries another database, the conditions in the other database may include the term “(disease)” to disambiguate the disease from other terms with the same name (e.g., “Cancer” has close to seven entries in some databases, in addition to a single entry for the disease, including one for astrology and one for the constellation). Knowing this, a user may adjust the weight of the otherwise common token “disease” to increase the likelihood of a correct link.

Link discovery between values often requires the use of domain knowledge. In a number of domains, there are existing and commonly accepted, semantic knowledge bases that may be used to this end. In domains where such semantic knowledge is not available, users often manually define and maintain their own knowledge bases.

In addition to receiving linkage specifications, the method 200 may further include receiving data source specifications at block 202. The data source specifications may include at least one data source from which to consider relational data for link creation based on the received linkage specifications. For example, the data source specifications may include identification of local and remote data sources such as databases, networked storage systems, websites, and/or any other suitable data source. The linkage specifications and the data source specifications, if taken together, form a basic query. This query, as described using basic declarative language as described in Table 1, may be at first incompatible with existing standard query languages used by data sources included in the data source specifications.

Therefore, the method 200 further includes translating the query at block 203. The query may be translated to a standard query language, for example Structured Query Language (SQL), through the use of two basic algorithms. The first algorithm termed “LINQL2SQL” is described below with reference to Table 2:

TABLE 2
(LINQ2SQL):

input : LinQL query L
output: SQL query Q

1 lce ← extract link clause expr. from L;
2 Q_{base} ← L − lce;
3 Q ← LINKCLAUSEEXPR2SQL(Q_{base}, lce );
4 return Q;

The second algorithm termed “LINKCLAUSEEXPR2SQL” is referenced by the first algorithm, and is described below with reference to Table 3:

TABLE 3
(LINKCLAUSEEXPR2SQL):

input : An SQL base template Q_{base}, a link clause expression lce
output: SQL query Q

| 1 if lce 6= Ø then | |
|---|---|
| 2 | l ←next link clause in lce; |
| 3 | Q ← LINKCLAUSE2SQL(Qbase, l); |
| 4 | if operator = AND then |

| | |
|---|---|
| 5 | Q ← LINKCLAUSEEXPR2SQL(Q, lce − l ); |

| | |
|---|---|
| 6 | else if operator = OR then |

| | |
|---|---|
| 7 | Q ← Q + ‘UNION’ + |

LINKCLAUSEEXPR2SQL(Qbase, lce − l );

9 return Q;

The translation operations of both the first and second algorithms is described with reference to Structured Query Language (SQL), however, it is understood that any standard query language is equally applicable to example embodiments depending upon any desired or necessary implementation.

The first algorithm translates a basic declarative language query to a SQL query by first dividing the basic declarative language query into a base query template (which is a standard query language template) and a link clause expression. The link clause expression is translated into SQL through the second algorithm by iterating through the boolean combination of link clauses and generating a separate SQL query for each clause. Subsequently, the boolean combination of link clauses is translated into a set of intersections/unions between the generated SQL queries.

The second algorithm parses a link clause to determine what type of link terminal is used. If the link terminal is a user defined function (UDF), an invocation of the UDF is added in the “where” clause of the SQL query base template. If the link terminal is a native link, the SQL query base template is re-written using the rewrite rules associated with that particular native link. If the link terminal is a reference to a named linkage specification, the associated linkage specification statement is retrieved and the associated link method is parsed. The link method may be a UDF, native link, or link clause expression. UDFs and native links are translated as described previously. Link clause expressions are translated by a recursive call to the second algorithm. The recursion terminates if either a UDF or a native link is encountered.

The translation logic includes rewriting rules associated with native links. A native link's rewriting rules are specified in two parts including view definitions and link conditions. Hereinafter, additional algorithms are presented with regards to translation of native link methods.

The rewriting of the approximate string matching native link specification into SQL consists of three steps, namely, the creation of tables containing the tokenization of the strings into q-grams or word tokens, the gathering of statistics and calculation of token weights from the token tables, and the calculation of link scores based on the weights.

The creation of tables containing the tokenization of the strings into q-grams or word tokens may be performed fully in SQL using standard string functions present in almost every DBMS. For example, a table of integers exists that stores integers 1 to N (maximum allowable length of a string). Basic string functions SUBSTR and LENGTH may be used along with the sequence of integers in table integers to create substrings of length q from the string column col1 in table tableA. The following SQL code shows this idea for q=3:

TABLE 4

SELECT tid, SUBSTR(col1,integers.i,3) as token
FROM integers INNER JOIN tableA

ON integers.i <= LENGTH(col1) + 2

In practice, the string coil is used along with UPPER( ) (or LOWER( )) functions to make the search case insensitive. Also, the string may be padded with q−1 occurrences of a special character not in any word (e.g. ‘$’) at the beginning and end using the CONCAT( ) function. Similarly spaces in the string are replaced by q−1 special characters. In case of tokenization using word tokens a similar SQL-based approach may be used. At the end of this process, the token generation queries are declared as views, or are materialized in tables such as tableA_col1_tokens and tableB_col2_tokens.

The gathering of statistics and calculation of token weights from the token tables, and the calculation of link scores based on the weights are partly native-link specific and are more easily presentable through an example. Hereinafter, the weighted Jaccard specification is used as an example.

TABLE 5

SELECT PV.visitid, CT.trial
FROM visit AS PV, trial AS CT
WHERE PV.visitid = 1234 AND CT.city=’NEW YORK’ AND

PV.diag = CT.cond

LINK PV.diag WITH CT.cond
USING weightedJaccard

The link specification of Table 5 is translated into the SQL queries of Table 6. Initially, two queries calculate the IDF weights for the tokens and the auxiliary views/tables needed for the final score calculation:

TABLE 6

CREATE VIEW visit_diagnosis_weights AS
SELECT token, LOG(size − df + 0.5) − LOG(df+0.5) as

weight

FROM ( SELECT token, count(*) as df
FROM (SELECT * FROM visit_diagnosis_tokens
GROUP BY tid, token) f
GROUP BY token ) D,
( SELECT count(*) as size
FROM visit_diagnosis_tokens ) S
CREATE VIEW visit_diagnosis_sumweights AS
SELECT tid, B.token, weight
FROM visit_diagnosis_tokenweights idf,
(SELECT DISTINCT tid, token
FROM visit_diagnosis_tokens B) B
WHERE B.token = idf.token
CREATE VIEW visit_diagnosis_tokenweights AS
SELECT tid, sum(weight) as sumw
FROM visit_diagnosis_weights
GROUP BY tid

A subsequent query returns the links along with their final scores:

TABLE 7

WITH scores(tid1, tid2, score) AS (
SELECT tid1, tid2,
(SI.sinter/(BSUMW.sumw+QSUMW.sumw-SI.sinter))
AS score
FROM (SELECT BTW.tid AS tid1,QT.tid AS tid2,
SUM(BTW.weight) AS sinter
FROM (SELECT * FROM visit_diagnosis_weights
WHERE id = 1234) AS BTW,
trials_condition_tokens AS QT
WHERE BTW.token = QT.token
GROUP BY BTW.tid, QT.tid) AS SI,
(SELECT *
FROM visit_diagnosis_sumweights
WHERE id = 1234 ) AS BSUMW,
(SELECT Q.tid, SUM(BTW.weight) AS sumw
FROM trials_condition_tokens Q,
visit_diagnosis_tokenweights AS BTW

WHERE 1=1 AND Q.token = BTW.token

GROUP BY Q.tid ) AS QSUMW

WHERE BSUMW.tid=SI.tid1 and

SI.tid2 = QSUMW.tid )

SELECT PV.visitid, CT.trial
FROM scores AS S, visit AS PV, trials AS CT,
WHERE PV.visitid = 1234 AND CT.city=’NEW YORK’ AND

| | | | |
|---|---|---|---|
| S.tid1=PV.visitid | AND | S.tid2=t.trial | AND |

S.score>0.5

As an example scenario, the synonym and hyponym data are stored in two tables, synonym and hyponym, with columns src and tgt. The column src contains concept IDs of the terms, and the column tgt contains the terms. Alternatively, this data may be stored in a table thesaurus with an additional column rel that stores the type of the relationship, or it may be stored in extensible mark-up language (XML). In the case of XML, synonym and hyponym may be views defined in a hybrid XML relational DBMS such as DB2. For the sake of brevity, this disclosure includes discussion of semantic knowledge stored as relational data, although example embodiments are extensible to other formats. The details of the SQL implementation of the synonym and hyponym native link specifications are show in Tables 8-9:

TABLE 8

SELECT PV.visitid, CT.trial
FROM visit AS PV, trial AS CT
WHERE PV.visitid = 1234 AND CT.city=’NEW YORK’ AND

PV.diag = CT.cond

LINK PV.diag WITH CT.cond
USING synonym

which is re-written to:

TABLE 9

SELECT DISTINCT PV.visitid, CT.trial
FROM trials AS CT, visit AS PV, synonym AS syn
WHERE PV.visitid = 1234 AND CT.city=’NEW YORK’ AND
(src in (SELECT src
FROM synonym s
WHERE s.tgt = CT.cond))
AND PV.diag = syn.tgt
UNION
SELECT PV.visitid, CT.trial
FROM trials AS CT, visit AS PV
WHERE PV.visitid = 1234 AND CT.city=’NEW YORK’ AND
CT.cond = PV.diag

For the hyponym example, Tables 10-11 are provided:

TABLE 10

SELECT PV.visitid, CT.trial
FROM visit AS PV, trial AS CT
WHERE PV.visitid = 1234 AND CT.city =’NEW YORK’ AND

PV.diag = CT.cond

LINK PV.diag WITH CT.cond
USING hyponym

Which is re-written to:

TABLE 11

WITH traversed(src, tgt, depth) AS (
(SELECT src, tgt, 1
FROM hyponym AS ths
UNION ALL
(SELECT ch.src, pr.tgt, pr.depth+1
FROM hyponym AS ch, traversed AS pr
WHERE pr.src=ch.tgt AND
pr.depth<2 AND ch.src!=‘root_node’))
SELECT distinct PV.visitid, CT.trial
FROM trials AS CT, visit AS PV, hyponym AS ths
WHERE PV.id = 1234 AND CT.city =’NEW YORK’ AND
(src in (SELECT distinct src
FROM traversed tr
WHERE tr.tgt = CT.cond)) AND
PV.diag = ths.tgt

Turning back to FIG. 2, upon execution of the query at block 204, the query results are returned at block 205. As an alternative to simply receiving linkage specifications, and as noted above, users may define parameters to fully describe linkage methods/algorithms (i.e., UDFs and native methods).

Each native link specification results in a distinct query which can be evaluated independently. However, in certain settings, the queries of different native link specifications need to cooperate. This is the case when the user sets a global linklimit value. Then, the queries from different link specifications need to cooperate so that we avoid running potentially expensive linkage queries when there are already enough links returned to the user. To achieve such cooperation, the LINKCLAUSEEXPR2SQL algorithm needs to be modified. We assume that the sequence of the specifications reflects their importance, i.e., the specification that appears first must be evaluated first. To this end, a condition must be added at the end of each SQL code to limit the number of results returned (using, for example, MySQL's LIMIT). Then, in Algorithm LINKCLAUSEEXPR2SQL, in addition to using UNION another condition should be added at the end of each query (in their WHERE clause) to check for the number of links returned by the previous query.

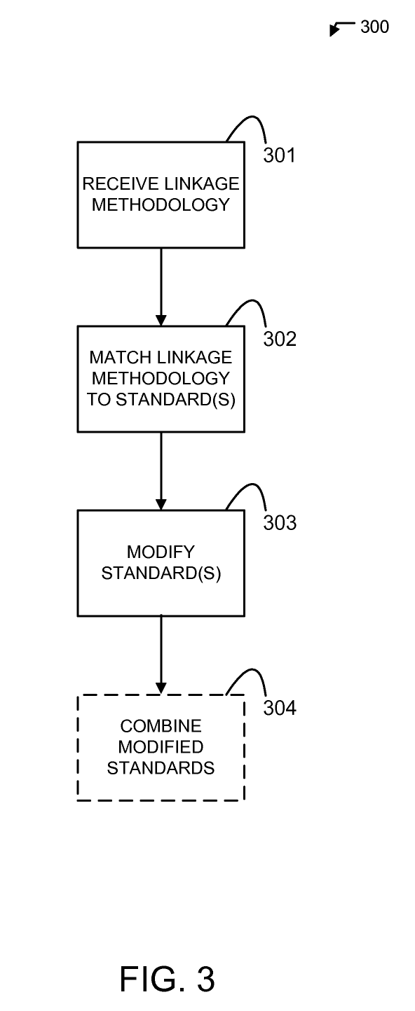

FIG. 3 is a flowchart of a method of semantic link discovery, according to an example embodiment. The method 300 may include receiving a linkage methodology at block 301. For example, the linkage methodology may include a plurality of parameters describing a methodology. The methodology may be a UDF or a native function, or any combination thereof. The method 300 further includes matching the linkage methodology to standard language methodologies, for example SQL re-writes of the received methodologies. Thereafter, the method 300 includes modifying the matched standard methodologies. For example, the parameters of the matched standard methodologies may be replaced by the received parameters of the received linkage methodologies.

It is noted that the received linkage methodologies may include one or more methodologies. Therefore, the method 300 may further include combining the modified standard methodologies at block 304. Additionally, it is noted that parts or all of methods 200 and 300 may be combined.

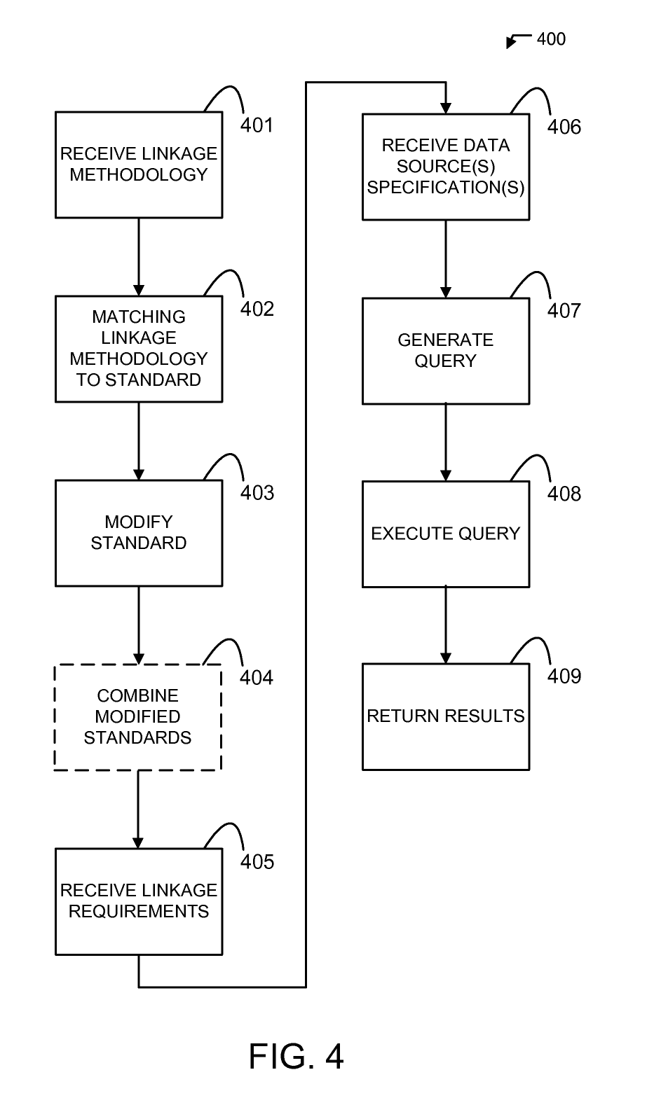

FIG. 4 is a flowchart of a method of semantic link discovery, according to an example embodiment. The method 400 may be considered a combined method comprised of feature of both methods 200 and 300. The method 400 includes receiving linkage methodologies at block 401. The received methodologies may be matched to standard methodologies (402), the standard methodologies may be modified and/or combined (403-404).

Additionally, the method 400 includes receiving linkage specifications and data source specifications (405-406). The method 400 may further include translating the query represented by the received linkage specifications, data source specifications, and modified/combined standard methodologies at block 407. Thereafter the query may be executed and results returned to the user (408-409).

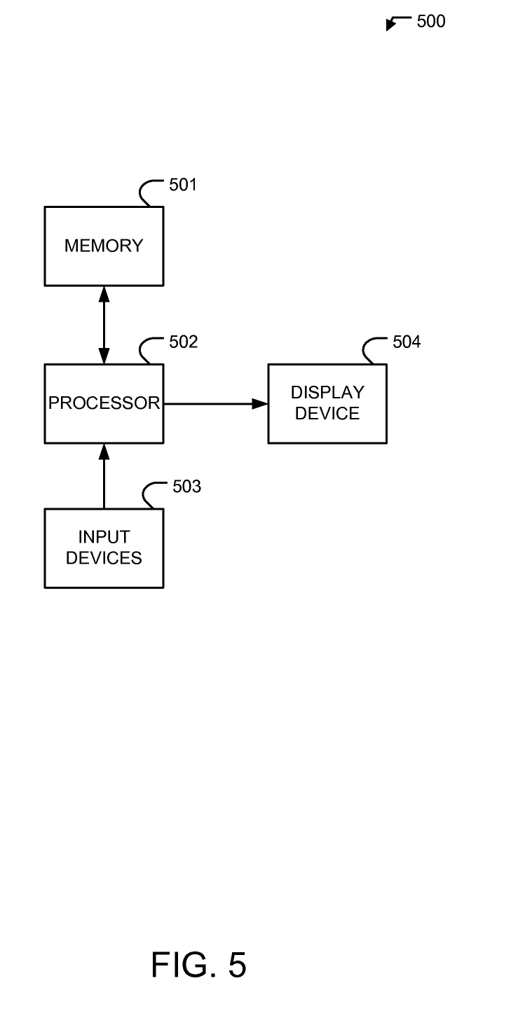

As described in detail herein, example embodiments provide methods of semantic link discovery over relational data. Additionally, the methodologies and systems of example embodiments of the present invention may be implemented in hardware, software, firmware, or a combination thereof. For example, according to an exemplary embodiment, the methodologies described hereinbefore may be implemented by a computer system or apparatus. For example, FIG. 5 illustrates a computer apparatus, according to an exemplary embodiment. Therefore, portions or the entirety of the methodologies described herein may be executed as instructions in a processor 502 of the computer system 500. The computer system 500 includes memory 501 for storage of instructions and information, input device(s) 503 for computer communication, and display device 504. Thus, the present invention may be implemented, in software, for example, as any suitable computer program on a computer system somewhat similar to computer system 500. For example, a program in accordance with the present invention may be a computer program product causing a computer to execute the example methods described herein.

The computer program product may include a computer-readable medium having computer program logic or code portions embodied thereon for enabling a processor (e.g., 502) of a computer apparatus (e.g., 500) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks, cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited the embodiments disclosed for carrying out this invention, but that the invention includes all embodiments falling with the scope of the appended claims. Moreover, the use of the terms first, second, etc. does not denote any order of importance, but rather the terms first, second, etc. are used to distinguish one element from another.

What is claimed is:

1. A method of semantic link discovery through translation of basic declarative language, comprising:
receiving a set of linkage specifications;
receiving a set of data sources related to the linkage specifications, the set of data sources and the set of linkage requirements forming a basic declarative language query, the basic declarative language query including specialized terms directed to linkage specifications;
translating the basic declarative language query into a standard language query;
executing the standard language query; and
returning results of the standard language query in response to the executing.

2. The method of claim 1, wherein the set of linkage specifications includes a linkage method and a threshold.

3. The method of claim 2, wherein the threshold is an upper limit of the number of returned results.

4. The method of claim 2, wherein the linkage method is one of a native linkage method and a user-defined linkage method.

5. The method of claim 4, wherein the user-defined linkage method is a Boolean representation of a string matching algorithm.

6. The method of claim 4, wherein the native linkage method is a linkage method native to the standard language query.

7. The method of claim 4, wherein the native linkage method is one of a Jaccard similarity method, an intersection size method, a weighted Jaccard similarity method, and a weighted intersection size method.

8. The method of claim 1, wherein the translating includes dividing the basic declarative language query into a base query template of the standard language used by the standard language query and a link clause expression, wherein:
the link clause expression is a Boolean combination of separate link clauses, and each separate link clause is a semantic Boolean condition of two columns of relational data included in the source data specifications; and
the base query template is a template associated with the standard language query and provides a skeleton for the translation.

9. The method of claim 1, wherein the linkage specifications includes one of a specification to match based on string similarity, a specification to match based on semantic information of type synonyms, and a specification to match based on semantic information of type hyponyms or hypernyms.

10. The method of claim 9, further comprising receiving parameters describing the string similarity, the semantic specification of type synonyms, or the semantic information of type hyponyms or hypernyms.

11. The method of claim 10, further comprising determining a generic standard language rewrite of the string similarity, the semantic specification of type synonyms, or the semantic information of type hyponyms or hypernyms.

12. The method of claim 11, further comprising replacing parameters of the standard language rewrite with parameters included in the received linkage specifications.

13. A method of semantic link discovery through translation of basic declarative language, comprising:
receiving a set of linkage requirements;
receiving a set of primitive linkage specifications;
receiving a set of data sources related to the primitive linkage specifications and linkage requirements, the set of data sources, the set of primitive linkage requirements, and the set of linkage requirements forming a basic declarative language query, the basic declarative language query including specialized terms directed to linkage specifications;
translating the basic declarative language query into a standard language query;
executing the standard language query; and
returning results of the standard language query in response to the executing.

14. The method of claim 13, wherein the translating includes dividing the basic declarative language query into a base query template of the standard language used by the standard language query and a link clause expression representing the set of linkage requirements and the primitive linkage specifications.

15. The method of claim 14, wherein the link clause expression is a Boolean combination of separate link clauses, and each separate link clause is a semantic Boolean condition of two columns of relational data included in the source data specifications.

16. The method of claim 15, wherein the base query template is a template associated with the standard language query and provides a skeleton for the translation.

17. The method of claim 1, wherein the primitive linkage specifications includes one of a specification to match based on string similarity, a specification to match based on semantic information of type synonyms, and a specification to match based on semantic information of type hyponyms or hypernyms, and wherein the method further comprises:
receiving parameters describing the string similarity, the semantic specification of type synonyms, or the semantic information of type hyponyms or hypernyms; and
determining a generic standard language rewrite of the string similarity, the semantic specification of type synonyms, or the semantic information of type hyponyms or hypernyms.

18. A computer readable storage medium including computer executable instructions that, when executed on a computer processor, direct the computer processor to perform a method of semantic link discovery through translation of basic declarative language, the method comprising:
receiving a set of linkage specifications;
receiving a set of data sources related to the linkage specifications, the set of data sources and the set of linkage requirements forming a basic declarative language query, the basic declarative language query including specialized terms directed to linkage specifications;
translating the basic declarative language query into a standard language query;
executing the standard language query; and
returning results of the standard language query in response to the executing.

19. The computer readable storage medium of claim 18, wherein the set of linkage specifications includes a linkage method and a threshold.

20. The computer readable storage medium of claim 19, wherein the threshold is an upper limit of the number of returned results and wherein the linkage method is one of a native linkage method and a user-defined linkage method.
